(19) United States
(12) Patent Application Publication
(10) Pub. No.: US 2022/0003499 A1
(43) Pub. Date: Jan. 6, 2022

(54) INDIRECTLY HEATABLE ROTARY KILN, USE OF A NICKEL-BASED ALLOY AND USE OF AN INDIRECTLY HEATABLE ROTARY KILN

(71) Applicant: Riedhammer GmbH, Nuernberg (DE)

(72) Inventors: Andreas Hajduk, Nuernberg (DE); Franziskus Kuespert, Fuerth (DE); Andreas Overhoff, Langensendelbach (DE); Matthias Uhl, Sugenheim/Ullstadt (DE)

(21) Appl. No.: 17/366,336

(22) Filed: Jul. 2, 2021

(30) Foreign Application Priority Data
Jul. 3, 2020 (EP) 20183853.9

(51) Int. Cl. F27B 7/28; C22C 19/03

(52) U.S. Cl. CPC F27B 7/28; C22C 19/03

(57) ABSTRACT

The invention relates to an indirectly heatable rotary kiln, the use of a nickel-based alloy, and the use of an indirectly heatable rotary kiln.

The invention relates to an indirectly heatable rotary kiln, the use of a nickel-based alloy and the use of an indirectly heatable rotary kiln.

An indirectly heatable rotary kiln is a particular design of rotary kiln. As known from the prior art, a rotary kiln comprises a cylindrical rotary tube mounted for rotation about its longitudinal axis with its longitudinal axis slightly inclined with respect to the horizontal. During operation of the rotary kiln, the rotary kiln is heated and rotated about its longitudinal axis. Firing charge (i.e. material to be fired) is fed into the rotary kiln at the higher end of the rotary kiln. As a result of the inclination of the rotary kiln and its rotary motion, the firing charge either automatically moves continuously from the higher to the lower end of the rotary kiln. Alternatively, this movement can also be supported or caused by appropriate internals in the rotary kiln, for example spirals. During this passage of the firing charge through the rotary kiln, heat is applied to the firing charge for the desired duration and temperature. The duration of the passage of the firing charge through the rotary kiln can be influenced by the inclination of the longitudinal axis, the length of the rotary kiln, the speed of rotation and—if present—the internals. During the passage of the firing charge through the rotary kiln, it can be subjected to a firing temperature at the desired level.

In indirectly heated rotary kilns, in order to supply heat to the firing charge in the rotary kiln tube, the rotary kiln tube is indirectly heated. For this purpose, the rotary kiln is heated from the outside. For example, the rotary kiln can be heated from the outside by means of burners, such as gas burners, or electric heaters for indirect heating. In this respect, it is possible to heat the rotary kiln to temperatures well in excess of 1,000° C. The devices for heating the rotary kiln, for example burners or an electric heater, are usually arranged in an insulated housing surrounding the rotary kiln. During the passage of the firing charge through the rotary kiln, the firing charge is exposed to temperature, in particular by contact with the hot inner surface of the rotary kiln and by the thermal radiation radiated from the inner surface of the rotary kiln, and is thus thermally treated.

Indirectly heated rotary kilns are used in particular for the thermal treatment of bulk materials, for example granules, powders or nanopowders. The advantage of the thermal treatment of bulk materials in indirectly heated rotary kilns is in particular that they pass through a very precisely defined temperature profile in the indirectly heatable rotary kiln and can be treated under special process conditions, such as an inert or protective gas atmosphere.

In principle, indirectly heated rotary kilns have proven their worth for the thermal treatment of firing charge, in particular the bulk materials mentioned above.

However, especially for high-quality, high-purity firing charge or firing charge containing chemically aggressive components, there is a risk that the materials to be heated may become contaminated with components of the rotary kiln due to mechanical abrasion by the firing charge in the rotary kiln during the firing process or due to chemical reactions of the firing charge with the rotary kiln. This effect can be further enhanced in different applications by the kiln atmosphere required in each case, for example a kiln atmosphere with a high oxygen content. Since such contamination is unacceptable for a wide range of products, the use of an indirectly heated rotary kiln for the thermal treatment of numerous firing charge has so far been out of the question.

In the past, there has been no lack of attempts to provide an indirectly heatable rotary kiln comprising an indirectly heatable rotary tube made of a material by means of which the aforementioned contamination of firing charge, i.e. in particular of firing charge in the form of high-quality, high-purity products, is avoided. From the point of view of the necessary temperature resistance and static and dynamic load-bearing capacity of the material of the rotary kiln, however, there are limits to the possible selection of the material of the rotary kiln. As a result, even if the material of the rotary kiln tube of an indirectly heatable rotary kiln can be adapted to the requirements of the firing charge, the use of an indirectly heatable rotary kiln for certain firing charge has so far been out of the question.

The invention is based on the object of providing an indirectly heatable rotary kiln which can be used for the thermal treatment of a very wide range of firing charge, in particular a wider range of firing charge than is possible with the indirectly heatable rotary kilns known from the prior art. In particular, the invention is based in this respect on the object of providing an indirectly heatable rotary kiln which can also be used for the thermal treatment of high-quality, in particular high-purity products which must not be contaminated or only to a very small extent during the thermal treatment in the rotary kiln, in particular must not be contaminated or only to a very small extent by components of the indirectly heatable rotary kiln of the indirectly heatable rotary kiln.

To solve this problem, an indirectly heatable rotary kiln is provided according to the invention, which comprises the following features:

An indirectly heatable rotary kiln tube;
the rotary kiln tube has a nickel-based alloy coating on the inside.

Surprisingly, it has been found in accordance with the invention that the aforementioned objects can be solved in that the rotary kiln tube of the indirectly heatable rotary kiln has on its inside a coating in the form of a nickel-based alloy.

The invention is based in particular on the realization according to the invention that it is not technically possible to provide an indirectly heatable rotary kiln tube which, on the one hand, has such a temperature resistance and static and dynamic load capacity that it can withstand the thermal and physical stresses to which a rotary kiln tube is subjected in an indirectly heated rotary kiln, and on the other hand also has such mechanical strength, in particular abrasion resistance, and chemical or corrosive resistance that contamination of the firing charge by components of the material of the rotary kiln can be prevented. On the contrary, the inventors have recognized that the objects according to the invention can only be solved if the rotary kiln consists of different materials. According to the invention, the rotary tube consists to this extent of a material which is coated on the inside with another material, namely according to the invention a material in the form of a nickel-based alloy. This makes it possible to optimize the material of the rotary tube specifically with respect to the required temperature resistance as well as static and dynamic load capacity, while the coating material can also be optimized specifically with respect to its requirements for a mechanical strength, in particular abrasion resistance, as well as chemical resistance, in particular corrosion resistance, in addition to a temperature resistance.

According to the invention, it was surprisingly recognized that an indirectly heatable rotary kiln tube of an indirectly heatable rotary kiln can, on the one hand, be excellently coated on the inside by a nickel-based alloy. On the other hand, it was recognized according to the invention that such a nickel-based alloy can provide a material which has excellent properties from the point of view of the aforementioned mechanical and chemical strength. In particular, on the basis of such a nickel-based alloy, a material can be made available which, when in contact with high-quality, high-purity products during their thermal treatment in the rotary tube, releases practically no constituents by which the products could be contaminated.

Furthermore, nickel-based alloys exhibit not only good mechanical resistance (in particular also good abrasion resistance) and corrosion resistance, but also in particular excellent high-temperature resistance (creep resistance), so that they are also suitable for use at high temperatures in an indirectly heatable rotary kiln, in particular also for temperatures above 1,000° C., for example.

According to a preferred embodiment, a nickel-based alloy is provided which is suitable for service temperatures above 1,000° C., in particular for service temperatures above 1,100° C.

According to the invention, it has been found that the composition of the nickel-based alloy is possible in a very wide range in order to meet the required demands.

According to a preferred embodiment, the nickel-based alloy may be in the form of any of the following nickel-based alloys: Nickel-aluminum alloys, nickel-molybdenum alloys, nickel-tungsten carbide alloys, or low-alloy nickel alloys.

The nickel-based alloy may include a nickel (Ni) content in the range of 30-99.5%, more preferably in the range of 60-99.5%, and most preferably in the range of 60-90%.

All data given herein in % are data in % by mass and related to the total mass of the nickel-based alloy. The percentages of the alloying constituents of the nickel-based alloy further indicate the chemical composition of the nickel-based alloy.

According to one embodiment, the nickel-based alloy comprises, in addition to nickel, at least one of the following: Al (aluminum), Mo (molybdenum), WC (tungsten carbide), copper (Cu), titanium (Ti) or chromium (Cr).

According to one embodiment, it is provided that the nickel-based alloy comprises a total content of Al, Mo, WC, Cu, Ti and Cr in the range of 0.5-70%, more preferably in the range of 0.5-40% and particularly preferably in the range of 10-40%. At the same time, it may preferably be provided that the nickel-based alloy comprises the above-described proportions of nickel.

According to one embodiment, it is provided that the nickel-based alloy comprises a proportion of Al in the range of 0.5-20.0% and Ni in the range of 80.0-99.5%.

According to one embodiment, it is provided that the nickel-based alloy comprises a proportion of Mo in the range of 0.5-20.0% and Ni in the range of 80.0-99.5%.

According to one embodiment, it is provided that the nickel-based alloy comprises a proportion of WC in the range of 0.5-60.0% and Ni in the range of 40.0-99.5%.

In addition to the aforementioned alloying constituents, the nickel-based alloy may in principle comprise one or more of the further known alloying constituents for nickel-based alloys.

According to the invention, it is preferably provided that the coating has a thickness in the range of 0.1 mm to 1.5 mm. According to the invention, it has been found that if the thickness of the coating is less than 0.1 mm, there is a risk that the firing charge will come into contact with areas of the rotary kiln tube during the firing process in the rotary kiln, which could contaminate the firing charge. Furthermore, it has been found that when the thickness of the coating exceeds 1.5 mm, thermal stresses can occur in the coating, which can lead to damage to the coating. Further preferably, the coating has a thickness in the range of 0.2 to 1.0 mm, more preferably in the range of 0.4 to 0.8 mm, and even more preferably in the range of 0.5 to 0.6 mm.

In principle, the indirectly heatable rotary kiln can be internally coated with the nickel-based alloy according to the invention by all of the technologies known from the prior art. Preferably, the coating can be applied to the inside of the indirectly heatable rotary kiln tube by at least one of the following processes: thermal spraying or baking. As is known, thermal spraying is a technology in which the material forming the subsequent coating, in the present case therefore a nickel-based alloy, is first melted and then sprayed in a gas stream onto the surface to be coated, in the present case therefore the inside of the rotary kiln tube. According to a preferred embodiment of thermal spraying, the nickel-based alloy is applied to the inside of the rotary kiln tube by flame spraying, even more preferably by wire flame spraying.

As is known, during baking the material to be coated, i.e. according to the invention a nickel-based alloy, is first applied in powder form or as an emulsion to the surface to be coated, i.e. in the present case the inside of the rotary kiln tube, and then fired under an inert atmosphere.

The nickel-based alloy coating forms the inside of the rotary kiln tube. The nickel-based alloy coating thus forms the surface of the rotary kiln with which the firing charge in the kiln comes into contact when passing through the kiln.

According to a particularly preferred embodiment, the indirectly heatable rotary kiln tube is in the form of a metallic rotary kiln tube. According to the invention, it has been found that an indirectly heatable metallic rotary kiln tube and a nickel-based alloy coating can be optimally matched to each other in such a way that the rotary kiln tube has optimum temperature resistance and static and dynamic load-bearing capacity and, at the same time, optimum mechanical strength (in particular abrasion resistance) and chemical resistance due to the nickel-based alloy coating on its inner side. A particular advantage of a metallic rotary kiln tube is also, in particular, that the properties, especially the physical properties, of the rotary kiln tube and the coating can be optimally matched to each other. In particular, the thermal expansion behavior of a metallic rotary kiln tube and the nickel-based alloy coating can be optimally matched to one another and, in particular, can be adapted to one another. In particular, this also has the advantage that thermal stresses during the firing process, which could arise if the thermal expansion behavior of the rotary kiln tube and the coating differ, can be avoided.

In this respect, according to a preferred embodiment, it is also provided that the difference in the coefficient of linear expansion between the rotary kiln tube and the nickel-based alloy coating is <2.0, more preferably <1.5 and even more preferably <1.0. The coefficient of linear expansion is the coefficient of linear expansion α at 20° C. with a in 10⁻⁶·K⁻¹.

According to a preferred embodiment, the rotary kiln according to the invention has a rotary kiln tube made of steel, particularly preferably of a heat-resistant steel. Particularly preferably, a high-temperature steel is present, in particular a high-temperature steel which can be loaded, in particular dynamically loaded, at temperatures above 600° C., or also above 1,000° C. and particularly preferably also above 1,200° C.

According to a preferred embodiment, the rotary kiln according to the invention has a rotary kiln tube made of a heat-resistant steel, in particular a highly corrosion-resistant steel.

According to a preferred embodiment, it is provided that the rotary kiln according to the invention comprises a rotary kiln tube made of one of the following steels: Ferritic steel, nickel alloy steel, austenitic steel or steel made of a nickel-based material. Most preferably, the rotary kiln has a rotary kiln tube made of an austenitic steel.

According to the invention, it was found that the aforementioned steels, in particular austenitic steel, can be excellently coated on the inside with a nickel-based alloy and can thereby meet the aforementioned requirements in terms of high temperature resistance and static and dynamic load-bearing capacity of the rotary kiln tube as well as mutually matched properties, in particular physical properties of the rotary kiln tube and coating.

Insofar as the rotary kiln is made of steel, the steel of the rotary kiln tube and the nickel-based alloy are present in different alloys. As explained above, the steel of the rotary kiln tube is optimized in particular for high temperature resistance and static and dynamic load-bearing capacity of the rotary kiln tube. In contrast, the nickel-based alloy, as explained above, is optimized not only in terms of temperature resistance but also in particular with regard to its requirements for mechanical strength, especially abrasion resistance, and chemical resistance, especially corrosion resistance.

The rotary kiln tube of the rotary kiln according to the invention can, moreover, be designed according to the indirectly heatable rotary kiln tubes of indirectly heatable rotary kilns known from the prior art. Preferably, the rotary kiln tube has an inner diameter in the range of 100 to 3,000 mm. Furthermore, the rotary kiln preferably has a length in the range of 1,000 to 50,000 mm.

Beyond the aforementioned features according to the invention, the rotary kiln according to the invention can be designed according to the prior art. To this extent, the rotary kiln may be indirectly heatable according to technologies known in the prior art. In this respect, the rotary kiln according to the invention can have heating devices via which the rotary kiln tube can be heated indirectly, i.e. from the outside. These heating devices may in particular be burners, preferably gas burners, or electric heating devices. Preferably, it can be provided that the rotary kiln can be indirectly heated via these heating devices to temperatures of over 150° C., in particular also to temperatures of over 600° C., according to a preferred embodiment to over 1,000° C., further preferably to temperatures in the range from 1,000 to 1,200° C. and according to a particularly preferred embodiment to temperatures in the range from 1,100 to 1,200° C. The aforementioned temperatures refer to the inside of the rotary kiln tube, i.e. the area of the rotary kiln tube where the firing charge to be thermally treated by the rotary kiln tube is located when passing through the rotary kiln tube. In particular, the aforementioned temperatures refer to the inside of the rotary kiln tube in the region of the inlet, i.e., the higher end of the rotary kiln tube where the charge to be fired in the rotary kiln tube is fed into the rotary kiln tube.

Further, as known in the prior art, the rotary kiln tube may be rotatably mounted about its longitudinal axis with its longitudinal axis slightly inclined with respect to the horizontal, for example via roller bearings. Further, as known in the prior art, the rotary kiln tube may be mounted in an insulated housing surrounding the rotary kiln tube, and the heating means for the rotary kiln may also be disposed in said housing. Furthermore, the rotary kiln may comprise the devices known in the prior art for feeding the material to be fired into the rotary kiln tube, for removing the firing charge which has been thermally treated in the rotary kiln tube from the rotary kiln tube, for gas-tight sealing of the rotary kiln tube (for setting a desired kiln atmosphere), and for any cooling of the firing material to be thermally treated.

It is also an object of the invention to use the rotary kiln according to the invention for the thermal treatment of firing charge, in particular for the thermal treatment of firing charge in the form of bulk materials, in particular in the form of bulk materials in the form of granulates, powders or nanopowders. In particular, the rotary kiln is used for the thermal treatment of high-quality, in particular high-quality high-purity firing charge, in particular firing charge in the form of the aforementioned bulk materials, in particular in the form of such high-quality, high-purity firing charge, which must not be contaminated by the rotary kiln tube.

It is also an object of the invention to use a nickel-based alloy for coating the inside of an indirectly heatable rotary kiln tube. The nickel-based alloy is used in this case with the proviso that the rotary kiln tube is coated on the inside with the nickel-based alloy, in particular by the processes described above. In this use, the nickel-based alloy, the rotary kiln tube and the rotary kiln may have the features of the rotary kiln according to the invention disclosed herein.

Further features will be apparent from the claims, the exemplary embodiment, and the accompanying description of the embodiment.

All features of the invention may be combined, individually or in combination, in any desired manner.

In the following, an exemplary embodiment of a rotary kiln according to the invention is explained in more detail.

It shows, strongly schematized and not to scale,

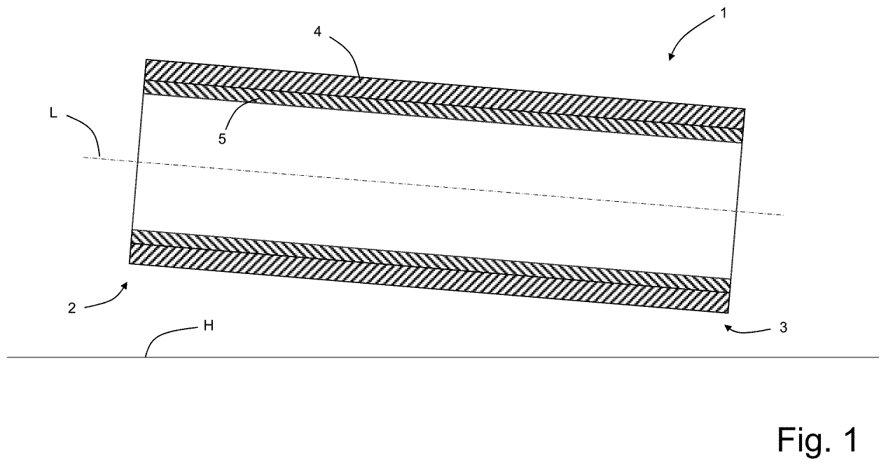

FIG. 1 a sectional view of a rotary kiln tube of a rotary kiln according to the invention along its longitudinal axis.

FIG. 1 shows the rotary kiln tube, designated in its entirety by the reference sign 1, of an indirectly heatable rotary kiln not shown in more detail. The rotary tube 1 has a substantially tubular shape with a longitudinal axis L. The rotary kiln tube 1 is rotatably mounted about its longitudinal axis L with a slight inclination of the longitudinal axis L with respect to the horizontal H. For this purpose, the rotary kiln tube 1 is rotatably mounted on a base via roller bearings, not shown, on which the rotary kiln tube 1 is mounted at its one, here higher end 2 and at its second, opposite, here lower end 3. The rotary kiln tube 1 consists of an austenitic steel tube 4, which has a coating of a nickel-based alloy 5 on the inside.

The rotary kiln tube 1 has a length (along the longitudinal axis L) of 2,500 mm and a clear diameter (perpendicular to the longitudinal axis L) of 186 mm.

The nickel-based alloy 5 has the following chemical composition:

Ni: 90% by mass
Al: 10% by mass.

The coating 5 has a thickness of 0.5 mm.

The difference in the coefficient of linear expansion α (at 20° with α in 10⁻⁶·K⁻¹) of the austenitic steel 4 and the nickel-based alloy 5 is less than 1.0.

To coat the austenitic steel 4 of the rotary kiln tube 1 with the nickel-based alloy 5, the nickel-based alloy 5 was applied to the inner surface of the austenitic steel 4 of the rotary kiln tube 1 by wire flame spraying.

The rotary kiln tube 1 can be indirectly heated from the outside by means of an electric heater not shown in detail.

In the practical application, the rotary kiln tube 1 is indirectly heated from the outside via the electric heater.

Furthermore, material to be thermally treated is fed into the rotary kiln tube 1 in the area of the upper end 2 via a device not shown in more detail. At the same time, the rotary kiln tube 1 is rotated about its longitudinal axis L via drive means not shown in more detail. The heating devices heat the rotary kiln tube 1 and transfer this heat to the firing charge located in the rotary kiln tube 1. At the same time, due to the rotational movement of the rotary kiln tube 1 about its longitudinal axis L, the firing charge moves towards the lower end 3 of the rotary kiln tube 1. During this passage of the firing charge through the rotary kiln tube 1, the firing charge is thermally treated in the rotary kiln tube 1. After the firing charge has passed through the rotary kiln tube 1, it is removed from the rotary kiln tube 1 by means of devices not shown in more detail.

The rotary kiln tube 1 is particularly suitable for the thermal treatment of firing charge in the form of high-quality, high-purity products, especially in the form of bulk materials, which must not be contaminated by the rotary kiln tube 1.

1. Indirectly heatable rotary kiln, comprising the following features:
1.1 An indirectly heatable rotary kiln tube (1);
1.2 the rotary kiln tube (1) has a nickel-based alloy coating (5) on the inside.

2. Rotary kiln according to claim 1, wherein the nickel-based alloy comprises a proportion of nickel in the range of 30-99.5%.

3. Rotary kiln according to claim 1, wherein the nickel-based alloy comprises, in addition to Ni, at least one of the following: Al, Mo or WC.

4. Rotary kiln according to claim 1, wherein the nickel-based alloy comprises a proportion of Al in the range of 0.5-20.0% and Ni in the range of 80.0-99.5%.

5. Rotary kiln according to claim 1, wherein the nickel-based alloy comprises a proportion of Mo in the range of 0.5-20.0% and Ni in the range of 80.0-99.5%.

6. Rotary kiln according to claim 1, wherein the nickel-based alloy comprises a proportion of WC in the range of 0.5-60.0% and Ni in the range of 40.0-99.5%.

7. Rotary kiln according to claim 1, wherein the coating (5) has a thickness in the range of 0.1 mm to 1.5 mm.

8. Rotary kiln according to claim 1, wherein the coating (5) is applied by at least one of the following processes: thermal spraying or baking.

9. Rotary kiln according to claim 1, comprising a metallic rotary kiln tube (1).

10. Rotary kiln according to claim 1 with a rotary kiln tube (1) made of steel.

11. Rotary kiln according to claim 1, comprising a rotary kiln tube (1) made of a heat-resistant steel.

12. Rotary kiln according to claim 1, comprising a rotary kiln tube (1) made of a heat-resistant steel.

13. Rotary kiln according to claim 1, comprising a rotary kiln tube (1) made of austenitic steel.

14. Use of a nickel-based alloy for the internal coating of an indirectly heatable rotary kiln tube of an indirectly heatable rotary kiln.

15. Use of the rotary kiln according to claim 1 for the thermal treatment of firing charge.
